(19) United States
(12) Patent Application Publication
(10) Pub. No.: US 2026/0366612 A1
(43) Pub. Date: Nov. 19, 2026

(54) COOLING AND LUBRICATING APPARATUS FOR ELECTRIC DRIVE ASSEMBLY, AND ELECTRIC DRIVE ASSEMBLY

(71) Applicant: Jing-Jin Electric Technologies Co., LTD., Beijing (CN)

(72) Inventors: Jianwen LI, Beijing (CN); Kaifei DENG, Beijing (CN); Chaoshuai DUAN, Beijing (CN); Ping YU, Beijing (CN)

(21) Appl. No.: 19/126,407

(22) PCT Filed: Jun. 2, 2023
(86) PCT No.: PCT/CN2023/098067

§ 371 Date: May 1, 2025

(30) Foreign Application Priority Data
Dec. 16, 2022 (CN) 202211627694.2

(51) Int. Cl. F16H 57/04; H02K 7/00; H02K 9/193

(52) U.S. Cl. CPC F16H 57/0476; F16H 57/0436; H02K 7/003; H02K 9/193

(57) ABSTRACT

A cooling and lubricating device of an electric drive assembly and an electric drive assembly are disclosed. The cooling and lubricating device comprises an oil pump assembly, an oil pump circuit and an oil return circuit. The oil pump circuit comprises an oil inlet pipe, an shaft inner oil passage and a first oil outlet pore that are communicated in sequence, the shaft inner oil passage extends axially in the motor shaft, the oil pump assembly pumps lubricating oil in the reducer housing into the shaft inner oil passage via the oil inlet pipe, the first oil outlet pore is provided on an outer circumference of the motor shaft and is used to sling the lubricating oil in the shaft inner oil passage to a part to be cooled and lubricated in the motor housing, an axial flow impeller is provided in the shaft inner oil passage and is used to pump the lubricating oil at an oil inlet end of the shaft inner oil passage towards an oil outlet end of the shaft inner oil passage. The oil return circuit is provided at a bottom of the motor housing and used to return the lubricating oil in the motor housing into the reducer housing. The cooling and lubricating device can ensure that each part to be cooled and lubricated in the motor housing can have sufficient lubricating liquid, and has the advantages such as good cooling and lubricating effect, simple structure, and low manufacturing cost.

### CROSS-REFERENCE TO RELATED APPLICATIONS

This application claims priority to the Chinese patent application No. 202211627694.2 filed with the Chinese Patent Office on Dec. 16, 2022 and entitled “Cooling and Lubricating Apparatus For Electric Drive Assembly, and Electric Drive Assembly”, which is incorporated by reference herein in its entirety.

### TECHNICAL FIELD

The present disclosure belongs to the technical field of cooling and lubrication of electric drive assemblies, and specifically relates to a cooling and lubricating device of an electric drive assembly and an electric drive assembly.

### BACKGROUND

With the continuous development of new energy vehicles, the requirements for the safety, power, energy consumption, noise and other related performances of the vehicle are increasingly higher. In order to enable the vehicle to adapt to various complex road conditions, the electric drive assembly of the vehicle needs to have technical characteristics such as high power, high torque, high speed, and high efficiency, and at the same time, higher requirements are put forward for the lubrication and cooling of the electric drive assembly.

Conventional gear oil thrower cannot meet the amount requirement of oil of various parts to be cooled and lubricated in the motor housing when the motor rotates at high speed. Thus, currently the method of providing a lubricating oil passage inside the motor shaft is mostly used for the cooling and lubrication of the motor. When the motor shaft rotates, the lubricating oil in the lubricating oil passage will be thrown to the parts that need cooling and lubrication due to the centrifugal force. However, when the motor speed is too high, the lubricating oil in the lubricating oil passage in the motor shaft will be thrown out with a higher speed, so that most lubricating oil will be thrown out when it flows to a front section of the lubricating oil passage, and a very small part of the lubricating oil can be left to the rear section of the lubricating oil passage, resulting in insufficient oil in the rear section of the lubricating oil passage. In this way, the parts to be cooled and lubricated at the rear section of the motor shaft cannot have sufficient lubricating liquid, resulting in poor cooling and lubrication effect of the electric drive assembly.

### SUMMARY

In view of the above problems, the present disclosure proposes a cooling and lubricating device of an electric drive assembly and an electric drive assembly to overcome or at least partially solve the above problems.

In order to achieve the above object, the present disclosure adopts the following technical solutions.

An aspect of the present disclosure provides a cooling and lubricating device of an electric drive assembly. The electric drive assembly comprises a motor and a reducer, the motor comprises a motor shaft and a motor housing, and the reducer comprises a reducer housing. The cooling and lubricating device comprises an oil pump assembly, an oil pump circuit and an oil return circuit;

the oil pump circuit comprises an oil inlet pipe, an shaft inner oil passage and a first oil outlet pore that are communicated in sequence, the shaft inner oil passage extends axially inside the motor shaft, the oil pump assembly pumps lubricating oil in the reducer housing into the shaft inner oil passage via the oil inlet pipe, the first oil outlet pore is provided on an outer circumference of the motor shaft and is used to sling the lubricating oil in the shaft inner oil passage to a part to be cooled and lubricated in the motor housing, an axial flow impeller is provided in the shaft inner oil passage and is used to pump the lubricating oil at an oil inlet end of the shaft inner oil passage towards an oil outlet end of the shaft inner oil passage;

the oil return circuit is provided at a bottom of the motor housing and used to return the lubricating oil in the motor housing into the reducer housing.

Further, the oil inlet end of the oil inlet pipe is connected to the oil pump assembly, the oil outlet end of the oil inlet pipe extends into the shaft inner oil passage in the motor shaft, an oil retaining ring is provided between the oil inlet pipe and the shaft inner oil passage, an outer circumference of the oil retaining ring is fitted to an inner wall of the shaft inner oil passage with interference, and an inner circumference of the oil retaining ring is fitted to an outer circumference of the oil inlet pipe with clearance.

Further, the axial flow impeller is provided upstream of the first oil outlet pore.

Further, a shaft of the axial flow impeller is fixedly connected to the oil inlet end of the oil inlet pipe.

Further, an oil outlet opening is provided on the oil outlet end of the oil inlet pipe.

Further, the reducer also comprises a reducer input shaft, the motor shaft and the reducer input shaft are an integral shaft that is integrally formed, and the shaft inner oil passage axially penetrates the integral shaft.

Further, the reducer also comprises a reducer output shaft, the reducer output shaft and the integral shaft are arranged coaxially, a fixed bearing is provided between the reducer output shaft and the integral shaft, an inner ring of the fixed bearing is fixedly connected to the integral shaft, and an outer ring of the fixed bearing is fixedly connected to the reducer output shaft;

a second oil outlet pore communicated with the shaft inner oil passage is provided on an outer circumference of a power output end of the integral shaft, the second oil outlet pore is arranged obliquely or parallel to an axis of the integral shaft, and the second oil outlet pore is used to cool and lubricate the fixed bearing.

Further, the first oil outlet pore is arranged obliquely or perpendicular to the axis of the motor shaft, and is used to cool and lubricate any one or more of a motor bearing, a stator winding or a rotor.

Further, the oil pump assembly comprises an electronic oil pump and an oil filter unit;

the electronic oil pump is communicated with the bottom of the reducer housing via the oil filter unit and pumps lubricating oil in the reducer housing into the oil inlet pipe, and the oil filter unit is used to filter the lubricating oil.

Another aspect of the present disclosure provides an electric drive assembly. The electric drive assembly comprises a motor and a reducer. The electric drive assembly uses the cooling and lubricating device as described above to cool and lubricate the motor.

The advantages and beneficial effects of the present disclosure are as follows.

In the cooling and lubricating device of the electric drive assembly of the present disclosure, by providing the axial flow impeller in the shaft inner oil passage in the motor shaft, the lubricating oil at the oil inlet end of the shaft inner oil passage can be pumped towards the oil outlet end of the shaft inner oil passage, so that sufficient lubricating oil can flow to the oil outlet end of the shaft inner oil passage. When the motor rotates, it can be ensured that all the parts to be cooled and lubricated in the motor housing can have sufficient lubricating oil, so that the cooling and lubrication effect of the electric drive assembly is better, thereby extending the service life of the electric drive assembly; moreover, the cooling and lubricating device also has the advantages such as simple structure and low manufacturing cost.

### BRIEF DESCRIPTION OF DRAWINGS

By reading the detailed description of the preferred embodiments below, various other advantages and benefits will become clear to a person of ordinary skill in the art. The accompanying drawings are only used for the purpose of illustrating the preferred embodiments, and should not be considered as a limitation to the present disclosure. Moreover, throughout the drawings, the same reference numerals are used to denote the same components. In the drawings:

FIG. 1 is a schematic view of the structure of a cooling and lubricating device of an electric drive assembly in an embodiment of the present disclosure;

FIG. 2 is a schematic view of the connection relationship between an oil inlet pipe and an axial flow impeller in an embodiment of the present disclosure;

FIG. 3 is a perspective view of the structure of an open axial flow impeller;

FIG. 4 is a schematic view of the position relationship between a closed axial flow impeller and a motor shaft in another embodiment of the present disclosure;

FIG. 5 is a perspective view of the structure of a closed axial flow impeller;

FIG. 6 is an axial cross-sectional view of a reducer input shaft in an embodiment of the present disclosure; and

FIG. 7 is an axial cross-sectional view of a reducer input shaft in another embodiment of the present disclosure.

In the drawings: 1, motor; 2, reducer; 3, motor shaft; 4, motor housing; 5, reducer housing; 6, pump oil assembly; 7, oil inlet pipe; 8, shaft inner oil passage; 9, first oil outlet pore; 10, motor bearing; 11, rotor; 12, stator winding; 13, axial flow impeller; 14, oil retaining ring; 15, oil outlet opening; 16, reducer input shaft; 17, reducer output shaft; 18, fixed bearing; 19, second oil outlet pore.

### DETAILED DESCRIPTION

In order to make the object, technical solutions, and advantages of the present disclosure clearer, the present disclosure will be described clearly and completely in conjunction with the specific embodiments and corresponding drawings. Obviously, the embodiments described are only part of rather than all of the embodiments of the present disclosure. Based on the embodiments in the present disclosure, all other embodiments obtained by those of ordinary skill in the art without paying creative work shall fall within the protection scope of the present disclosure.

The technical solutions provided by embodiments of the present disclosure will be described in detail in conjunction with the accompanying drawings.

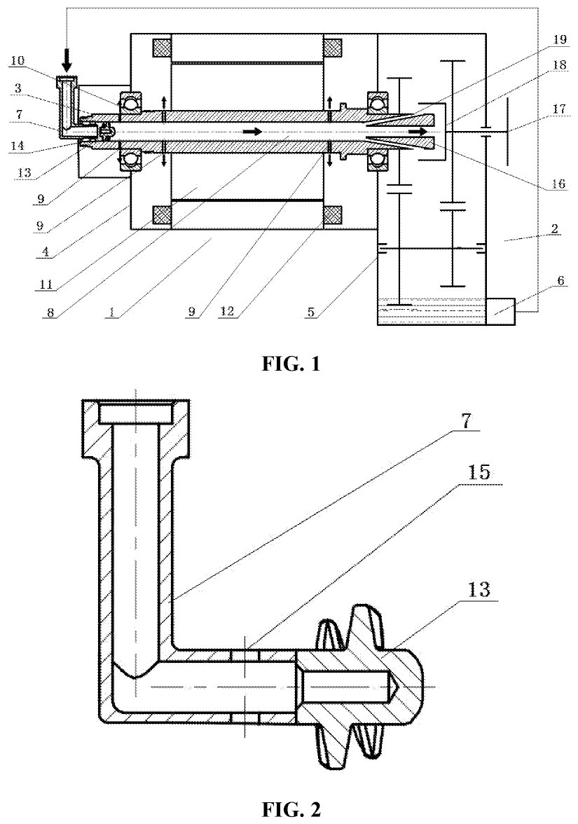

In an embodiment of the present disclosure, a cooling and lubricating device of an electric drive assembly is disclosed. As shown in FIG. 1, the electric drive assembly comprises a motor 1 and a reducer 2. The reducer 2 is arranged at a power output end of the motor 1. The motor 1 comprises a motor shaft 3 and a motor housing 4. The reducer 2 comprises a reducer housing 5. The cooling and lubricating device comprises an oil pump assembly 6, an oil pump circuit and an oil return circuit. The oil pump assembly 6 is used to pump the lubricating oil in the reducer housing 5 into the oil pump circuit.

Specifically, the pump oil circuit comprises an oil inlet pipe 7, a shaft inner oil passage 8 and a first oil outlet pore 9 that are communicated in sequence. The shaft inner oil passage 8 extends axially inside the motor shaft 3. The pump oil assembly 6 can pump the lubricating oil in the reducer housing 5 into the oil inlet pipe 7, and then the lubricating oil enters the shaft inner oil passage 8 via the oil inlet pipe 7. The first oil outlet pore 9 is arranged on the outer circumference of the motor shaft 3, and the orifice position of each first oil outlet pore 9 corresponds to a part to be cooled and lubricated in the motor housing 4. In this way, when the motor shaft 3 rotates, the first oil outlet pore 9 can sling the lubricating oil in the shaft inner oil passage 8 to the part to be cooled and lubricated in the motor housing 4, so as to realize the cooling and lubrication of this part. The number and position of the first oil outlet pore 9 can be adjusted according to actual needs, and the amount of lubricating oil reaching each part to be cooled and lubricated can be controlled by the size of the orifice of the first oil outlet pore 9.

Further, an axial flow impeller 13 is provided inside the shaft inner oil passage 8 in the motor shaft 3. When the motor shaft 3 rotates, the axial flow impeller 13 will generate axial pressure on the lubricating oil being in contact with the axial flow impeller 13, push the lubricating oil to flow forward, and thus pump the lubricating oil at the oil inlet end of the shaft inner oil passage 8 towards the oil outlet end of the shaft inner oil passage 8. In this way, it can be ensured that the amount of oil at the oil outlet end of the shaft inner oil passage 8 is sufficient, so that the amount of lubricating oil at each part of the shaft inner oil passage 8 is basically the same, and thus the parts to be cooled and lubricated at the rear section of the motor shaft 3 can have sufficient lubricating liquid. The parts to be cooled and lubricated may be a motor bearing 10, a rotor 11 and a stator winding 12. In addition, the oil inlet end of the shaft inner oil passage 8 is the end that is away from the reducer 2, and the oil outlet end of the shaft inner oil passage 8 is the end that is close to the reducer 2.

Further, the oil return circuit is arranged at the bottom of the motor housing 4, and is used to return the lubricating oil in the motor housing 4 to the reducer housing 5.

The flow path of the lubricating oil in the electric drive assembly is as follows. The lubricating oil at the bottom of the reducer housing 5 is pumped into the oil inlet pipe 7 by the oil pump assembly 6, and then the lubricating oil flows from the oil inlet pipe 7 into the shaft inner oil passage 8. The lubricating oil in the shaft inner oil passage 8 is conveyed to the parts to be cooled and lubricated in the motor housing 4 via the first oil outlet pore 9. After the cooling and lubricating process is completed, the lubricating oil returns to the bottom of the motor housing 4 due to gravity, and finally returns to the reducer housing 5 via the oil return circuit.

In sum, in the cooling and lubricating device of the electric drive assembly according to this embodiment, by providing an axial flow impeller inside the shaft inner oil passage in the motor shaft, the lubricating oil at the oil inlet end of the shaft inner oil passage can be pumped towards the oil outlet end of the shaft inner oil passage, so that sufficient lubricating oil can flow to the oil outlet end of the shaft inner oil passage. When the motor rotates, it can be ensured that all the parts to be cooled and lubricated in the motor housing can have sufficient lubricating oil, so that the cooling and lubrication effect of the electric drive assembly is better, thereby extending the service life of the electric drive assembly; moreover, the cooling and lubricating device also has the advantages such as simple structure and low manufacturing cost.

In this embodiment, as shown in FIG. 1, the oil inlet pipe 7 is fixedly connected to the motor housing 4, an oil inlet end of the oil inlet pipe 7 is connected to the oil pump assembly 6, and an oil outlet end of the oil inlet pipe 7 extends into the shaft inner oil passage 8 in the motor shaft 3. A clearance is provided between the oil inlet pipe 7 and the inner wall of the shaft inner oil passage 8 so that the oil inlet pipe 7 does not rotate with the motor shaft 3. An oil retaining ring 14 is provided between the oil inlet pipe 7 and the shaft inner oil passage 8. The outer circumference of the oil retaining ring 14 is fitted to the inner wall of the shaft inner oil passage 8 with interference, and the inner circumference of the oil retaining ring 14 is fitted to the outer circumference of the oil inlet pipe 7 with clearance, so that the lubricating oil can be prevented from flowing out from the gap between the oil inlet end of the shaft inner oil passage 8 and the oil outlet end of the oil inlet pipe 7, thereby ensuring that the lubricating oil can enter the shaft inner oil passage 8.

In addition, the axial flow impeller 13 is arranged upstream of the first oil outlet pore 9. The upstream refers to the side close to the oil inlet pipe 7. In this embodiment, as shown in FIG. 1, there may be one axial flow impeller 13, and the axial flow impeller 13 is arranged between the oil outlet end of the oil inlet pipe 7 and the first oil outlet pore 9. In other embodiments, as shown in FIG. 4, there may be multiple axial flow impellers 13, and the multiple axial flow impellers 13 are respectively arranged between the oil outlet end of the oil inlet pipe 7 and the first oil outlet pore 9, or between the first oil outlet pores 9. When the motor shaft 3 rotates at high speed, the lubricating oil in the shaft inner oil passage 8 will move circumferentially along with the motor shaft 3, so that the lubricating oil adheres to the inner wall of the shaft inner oil passage 8 and does not flow towards the first oil outlet pore 9. By arranging the axial flow impeller 13 upstream of the first oil outlet pore 9, the axial flow impeller 13 can give the lubricating oil an axial thrust, so that the adhesion of the lubricating oil to the inner wall of the shaft inner oil passage 8 is weakened, and thus the lubricating oil can flow to the first oil outlet pore 9.

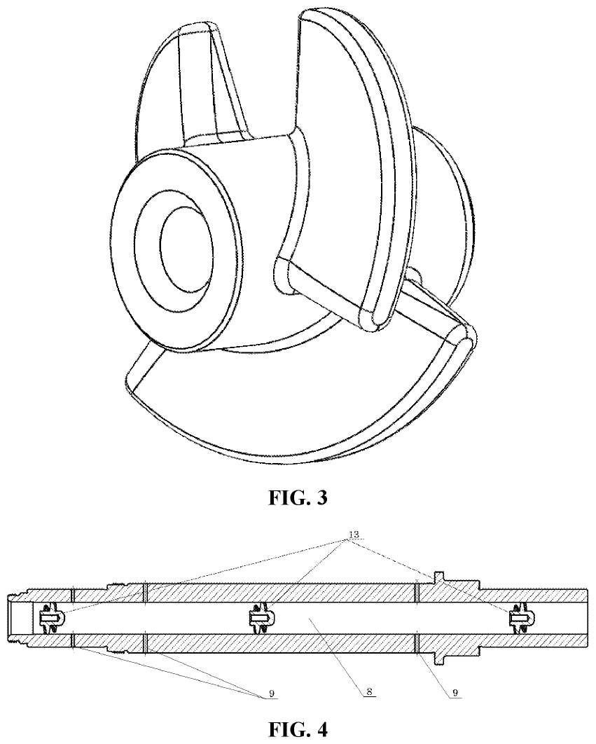

In addition, as shown in FIGS. 1 and 2, the shaft of the axial flow impeller 13 is fixedly connected to the oil inlet end of the oil inlet pipe 7. Specifically, the axial flow impeller 13 is fixedly connected to the oil inlet pipe 7 by a welding, riveting or threading structure. Of course, the axial flow impeller 13 can also form an integral structure with the oil inlet pipe 7. As shown in FIG. 3, the axial flow impeller 13 can be an open axial flow impeller. The open axial flow impeller is similar to the structure of a water pump impeller. When the motor shaft 3 rotates, the motor shaft 3 drives the lubricating oil in the shaft inner oil passage 8 to move circumferentially. The lubricating oil will rotate relative to the open axial flow impeller. In this way, the open axial flow impeller will generate axial pressure on the lubricating oil and push the lubricating oil to move axially.

Further, an oil outlet opening 15 is provided on the oil outlet end of the oil inlet pipe 7. The oil outlet opening 15 is specifically provided on the outer circumference of the oil inlet pipe 7 between the axial flow impeller 13 and the oil retaining ring 14. The lubricating oil in the oil inlet pipe 7 enters the shaft inner oil passage 8 via the oil outlet opening 15, and then contacts the axial flow impeller 13.

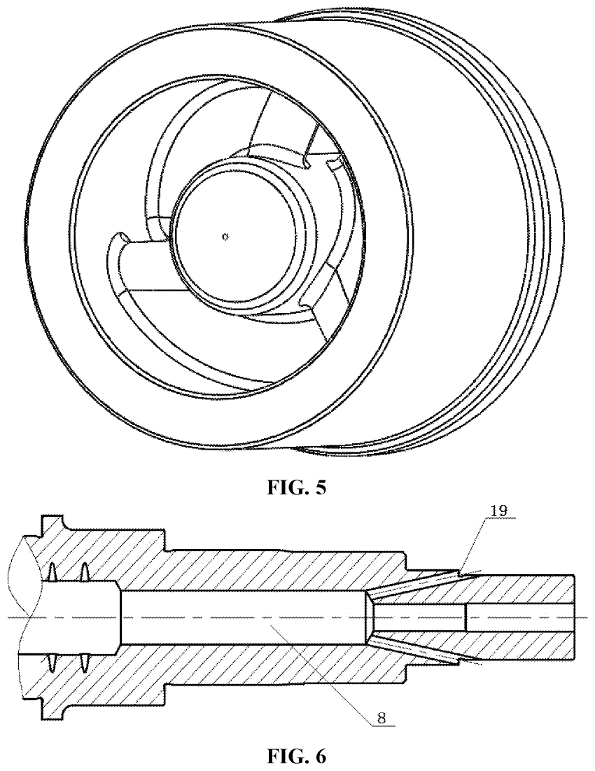

In other embodiments, as shown in FIG. 5, the axial flow impeller 13 may also be a closed axial flow impeller. The closed axial flow impeller is similar to adding an outer ring to the outer circumference of the open axial flow impeller. The outer ring of the closed axial flow impeller is fixedly connected to the inner wall of the shaft inner oil passage 8, so that it can rotate with the motor shaft 3. The outer ring of the closed axial flow impeller can be fixedly connected to the inner wall of the shaft inner oil passage 8 by spline or interference fit. Moreover, the closed axial flow impeller is specifically arranged in the shaft inner oil passage 8 between the oil outlet end of the oil inlet pipe 7 and the first oil outlet pore 9, and in the shaft inner oil passage 8 between first oil outlet pores 9. Alternatively, a closed axial flow impeller is provided only in the shaft inner oil passage 8 between the oil outlet end of the oil inlet pipe 7 and the first oil outlet pore 9. When the motor shaft 3 rotates, the motor shaft 3 will drive the lubricating oil in the shaft inner oil passage 8 to move circumferentially, but the rotation speed of the motor shaft 3 will be greater than the rotation speed of the lubricating oil, thereby causing the lubricating oil and the closed axial flow impeller to rotate relative to each other, so that the closed axial flow impeller will generate axial pressure on the lubricating oil and push the lubricating oil to move axially. Of course, both an open axial flow impeller and a closed axial flow impeller can be provided in the shaft inner oil passage.

In this embodiment, as shown in FIG. 1, the reducer 2 also comprises a reducer input shaft 16, the motor shaft 3 and the reducer input shaft 16 are an integral shaft that is integrally formed, and the shaft inner oil passage 8 axially penetrates the integral shaft, so that the lubricating oil can be delivered to the reducer housing 5 via the shaft inner oil passage 8 to achieve cooling and lubrication of the parts inside the reducer housing 5. In other embodiments, an axial flow impeller 13 can also be provided in the reducer input shaft 16, so that more lubricating oil can be delivered into the reducer housing 5.

Further, the reducer 2 also comprises a reducer output shaft 17. The reducer 2 outputs power via the reducer output shaft 17. The reducer output shaft 17 is arranged coaxially with the integral shaft. Moreover, a fixed bearing 18 is provided between the reducer output shaft 17 and the integral shaft, and is used to support and fix the reducer output shaft 17. Specifically, the inner ring of the fixed bearing 18 is fixedly connected to the integral shaft, and the outer ring of the fixed bearing 18 is fixedly connected to the reducer output shaft 17. Since the shaft inner oil passage 8 axially penetrates the integral shaft, the lubricating oil in the shaft inner oil passage 8 can flow out from the power output end of the integral shaft, thereby cooling the inner ring of the fixed bearing 18.

In addition, as shown in FIGS. 1 and 6, a second oil outlet pore 19 communicated with the shaft inner oil passage 8 is provided on the outer circumference of the power output end of the integral shaft. The second oil outlet pore 19 is arranged obliquely to the axis of the integral shaft, and the orifice of the second oil outlet pore 19 corresponds to the fixed bearing 18 and is used to cool and lubricate the outer ring and balls of the fixed bearing 18. Since the reducer input shaft 16 is a stepped shaft, in order to ensure the structural strength of the reducer input shaft 16, the shaft inner oil passage 8 in the reducer input shaft 16 is also a stepped structure. Since the shaft inner oil passage 8 in the reducer input shaft 16 is also a stepped structure, when the reducer input shaft 16 rotates at high speed, it is difficult for the lubricating oil to flow across the stepped structure, and it is impossible to cool and lubricate the fixed bearing 18. The second oil outlet pore 19 is provided to ensure that the lubricating oil can be delivered to the fixed bearing 18.

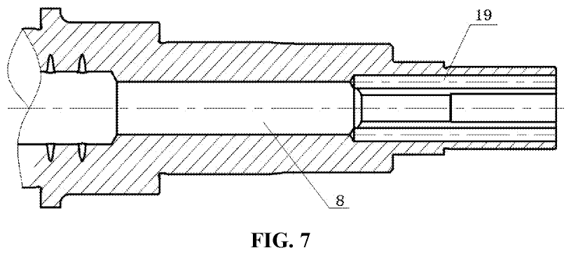

In other embodiments, as shown in FIG. 7, the second oil outlet pore 19 may also be arranged parallel to the axis of the integral shaft.

In this embodiment, as shown in FIG. 1 and FIG. 4, the first oil outlet pores 9 are arranged perpendicular to the axis of the motor shaft 3, and the orifices of the first oil outlet pores 9 correspond to the motor bearing 10 and the stator winding 12 and are used to cool and lubricate the motor bearing 10 and the stator winding 12. Of course, the first oil outlet pores 9 can also be used to cool and lubricate any one or more of the motor bearing 10, the rotor 11 or the stator winding 12. Moreover, the first oil outlet pores can also be arranged obliquely to the axis of the motor shaft 3.

Further, the oil pump assembly comprises an electronic oil pump and an oil filter unit.

The electronic oil pump is communicated with the bottom of the reducer housing via the oil filter unit, and pumps the lubricating oil in the reducer housing into the oil inlet pipe. The oil filter unit is used to filter the lubricating oil. Before the lubricating oil in the reducer housing enters the electronic oil pump, it is first filtered by the oil filter unit to filter out particles in the lubricating oil to prevent the particles from clogging the pump oil passage and affecting the normal operation of the electric drive assembly. Moreover, the oil filter unit is arranged at the bottom of the reducer housing, so that the bottom space of the reducer housing is fully utilized, and also the lubricating oil in the reducer housing can enter the oil filter unit for filtration under the action of gravity. In addition, the amount of oil an electronic oil pump pumps can be adjusted according to the rotation speed of the motor shaft. When the motor rotates at a low speed, the motor generates less heat, and the amount of oil an electronic oil pump pumps is small; when the motor rotates at a high speed, the motor generates more heat, and the amount of oil an electronic oil pump pumps is large. In this embodiment, by using an electronic oil pump to pump oil, the oil level in the reducer housing can be lowered, the oil stirring loss can be reduced, and thus the efficiency of the electric drive assembly is improved.

Further, in order to prevent the deterioration of the oil filter unit due to long-term use, the oil filter unit can be a detachable oil filter, and the filtering effect of the oil filter unit can be ensured by replacing the filter core.

In another embodiment of the present disclosure, an electric drive assembly is disclosed. The electric drive assembly comprises a motor and a reducer. The electric drive assembly uses the cooling and lubricating device as described in above embodiments to cool and lubricate the motor. The electric drive assembly has the advantages of good cooling and lubrication effect and long service life.

The above merely describes particular embodiments of the present disclosure. By the teaching of the present disclosure, a person skilled in the art can make other modifications or variations based on the above embodiments. A person skilled in the art should appreciate that, the detailed description above is only for the purpose of explaining the present disclosure, and the protection scope of the present disclosure should be subject to the protection scope of the claims.

1. A cooling and lubricating device of an electric drive assembly, the electric drive assembly comprising a motor and a reducer, the motor comprising a motor shaft and a motor housing, and the reducer comprising a reducer housing, wherein
the cooling and lubricating device comprises an oil pump assembly, an oil pump circuit and an oil return circuit;
the oil pump circuit comprises an oil inlet pipe, an shaft inner oil passage and a first oil outlet pore that are communicated in sequence, the shaft inner oil passage extends axially in the motor shaft, the oil pump assembly pumps lubricating oil in the reducer housing into the shaft inner oil passage via the oil inlet pipe, the first oil outlet pore is provided on an outer circumference of the motor shaft and is used to sling the lubricating oil in the shaft inner oil passage to a part to be cooled and lubricated in the motor housing, an axial flow impeller is provided in the shaft inner oil passage and is used to pump the lubricating oil at an oil inlet end of the shaft inner oil passage towards an oil outlet end of the shaft inner oil passage;
the oil return circuit is provided at a bottom of the motor housing and used to return the lubricating oil in the motor housing into the reducer housing.

2. The cooling and lubricating device of an electric drive assembly according to claim 1, wherein an oil inlet end of the oil inlet pipe is connected to the oil pump assembly, an oil outlet end of the oil inlet pipe extends into the shaft inner oil passage in the motor shaft, an oil retaining ring is provided between the oil inlet pipe and the shaft inner oil passage, an outer circumference of the oil retaining ring is fitted to an inner wall of the shaft inner oil passage with interference, and an inner circumference of the oil retaining ring is fitted to an outer circumference of the oil inlet pipe with clearance.

3. The cooling and lubricating device of an electric drive assembly according to claim 2, wherein the axial flow impeller is provided upstream of the first oil outlet pore.

4. The cooling and lubricating device of an electric drive assembly according to claim 3, wherein a shaft of the axial flow impeller is fixedly connected to the oil inlet end of the oil inlet pipe.

5. The cooling and lubricating device of an electric drive assembly according to claim 4, wherein an oil outlet opening is provided on the oil outlet end of the oil inlet pipe.

6. The cooling and lubricating device of an electric drive assembly according to claim 1, wherein the reducer also comprises a reducer input shaft, the motor shaft and the reducer input shaft are an integral shaft that is integrally formed, and the shaft inner oil passage axially penetrates the integral shaft.

7. The cooling and lubricating device of an electric drive assembly according to claim 6, wherein the reducer also comprises a reducer output shaft, the reducer output shaft and the integral shaft are arranged coaxially, a fixed bearing is provided between the reducer output shaft and the integral shaft, an inner ring of the fixed bearing is fixedly connected to the integral shaft, and an outer ring of the fixed bearing is fixedly connected to the reducer output shaft;
a second oil outlet pore communicated with the shaft inner oil passage is provided on an outer circumference of a power output end of the integral shaft, the second oil outlet pore is arranged obliquely or parallel to an axis of the integral shaft, and the second oil outlet pore is used to cool and lubricate the fixed bearing.

8. A cooling and lubricating device of an electric drive assembly according to claim 1, wherein the first oil outlet pore is arranged obliquely or perpendicular to the axis of the motor shaft, and is used to cool and lubricate any one or more of a motor bearing, a stator winding or a rotor.

9. A cooling and lubricating device of an electric drive assembly according to claim 1, wherein the oil pump assembly comprises an electronic oil pump and an oil filter unit;
the electronic oil pump is communicated with the bottom of the reducer housing via the oil filter unit and pumps lubricating oil in the reducer housing into the oil inlet pipe, and the oil filter unit is used to filter the lubricating oil.

10. An electric drive assembly comprising a motor and a reducer, wherein the electric drive assembly uses the cooling and lubricating device according to claim 1 to cool and lubricate the motor.

11. A cooling and lubricating device of an electric drive assembly according to claim 2, wherein the first oil outlet pore is arranged obliquely or perpendicular to the axis of the motor shaft, and is used to cool and lubricate any one or more of a motor bearing, a stator winding or a rotor.

12. A cooling and lubricating device of an electric drive assembly according to claim 6, wherein the first oil outlet pore is arranged obliquely or perpendicular to the axis of the motor shaft, and is used to cool and lubricate any one or more of a motor bearing, a stator winding or a rotor.

13. A cooling and lubricating device of an electric drive assembly according to claim 7, wherein the first oil outlet pore is arranged obliquely or perpendicular to the axis of the motor shaft, and is used to cool and lubricate any one or more of a motor bearing, a stator winding or a rotor.

14. A cooling and lubricating device of an electric drive assembly according to claim 2, wherein the oil pump assembly comprises an electronic oil pump and an oil filter unit;
the electronic oil pump is communicated with the bottom of the reducer housing via the oil filter unit and pumps lubricating oil in the reducer housing into the oil inlet pipe, and the oil filter unit is used to filter the lubricating oil.

15. A cooling and lubricating device of an electric drive assembly according to claim 6, wherein the oil pump assembly comprises an electronic oil pump and an oil filter unit;
the electronic oil pump is communicated with the bottom of the reducer housing via the oil filter unit and pumps lubricating oil in the reducer housing into the oil inlet pipe, and the oil filter unit is used to filter the lubricating oil.

16. A cooling and lubricating device of an electric drive assembly according to claim 7, wherein the oil pump assembly comprises an electronic oil pump and an oil filter unit;
the electronic oil pump is communicated with the bottom of the reducer housing via the oil filter unit and pumps lubricating oil in the reducer housing into the oil inlet pipe, and the oil filter unit is used to filter the lubricating oil.

17. An electric drive assembly comprising a motor and a reducer, wherein the electric drive assembly uses the cooling and lubricating device according to claim 2 to cool and lubricate the motor.

18. An electric drive assembly comprising a motor and a reducer, wherein the electric drive assembly uses the cooling and lubricating device according to claim 6 to cool and lubricate the motor.

19. An electric drive assembly comprising a motor and a reducer, wherein the electric drive assembly uses the cooling and lubricating device according to claim 8 to cool and lubricate the motor.

20. An electric drive assembly comprising a motor and a reducer, wherein the electric drive assembly uses the cooling and lubricating device according to claim 9 to cool and lubricate the motor.
